(19) United States
(12) Patent Application Publication
(10) Pub. No.: US 2013/0275049 A1
(43) Pub. Date: Oct. 17, 2013

(54) System and Method of Assessing Allergic Status in a Subject

(71) Applicants: Audrey Dunn-Galvin, Glanmire (IE); Jonathan B. O'Hourihane, Cork City (IE)

(72) Inventors: Audrey Dunn-Galvin, Glanmire (IE); Jonathan B. O'Hourihane, Cork City (IE)

(73) Assignee: University College Cork-National University of Ireland, Cork, Cork City (IE)

(21) Appl. No.: 13/698,660

(22) PCT Filed: May 18, 2011
(86) PCT No.: PCT/EP11/58085

§ 371 Date: Jun. 21, 2013

(30) Foreign Application Priority Data
May 18, 2010 (EP) 10163132.3

(51) Int. Cl. G06F 19/00

(52) U.S. Cl. CPC G06F 19/3431; G06F 19/3437
USPC 702/19; 703/2

(57) ABSTRACT

A method of assessing the allergic status of a subject to a specific allergen, comprises the steps of determining a subject-specific numeric value for a plurality of variables comprising age, sex, SPT, IgE, (sIgE or tIgE minus sIgE) and allergic symptoms, applying an allergen-specific weighting to the numeric value for each variable, and correlating the weighted numeric values with allergic status for the subject. The weighted numeric values is correlated with allergenicity status using a deterministic probability function.

### FIELD OF THE INVENTION

The invention relates to a system and method of assessing allergic status in a subject. In particular, the invention provides a system and method of predicting the outcome of oral food challenge in a subject.

### BACKGROUND TO THE INVENTION

Food allergy is an immune system reaction that occurs soon after eating a certain food. Even a tiny amount of the allergy-causing food can trigger signs and symptoms such as digestive problems, hives or swollen airways. In some people, a food allergy can cause severe symptoms or even a life-threatening reaction known as anaphylaxis. Tree nuts and peanuts are the leading causes of deadly allergic reactions called anaphylaxis.

Food allergy affects an estimated 6 to 8 percent of children under age 3, and about 4 percent of adults. While there's no cure, some children outgrow their food allergy as they get older. In adults, the foods that most often trigger allergic reactions include fish and shellfish, such as shrimp, lobster and crab, peanuts, tree nuts, such as walnuts, and eggs. Problem foods for children include eggs, milk (especially in infants and young children), and peanuts.

The last decade has shown both an increasing prevalence of food allergy and increasing numbers of patients and parents seeking diagnosis. While double-blind, placebo-controlled food challenges (DBPCFC) still represent the gold standard for the diagnosis of food allergy, they are time-consuming and expensive and they create some concerns for patients and parents, for example the fear and risk of severe systemic reactions. Many paediatric units routinely use open food challenges (OFC) outside research protocols. In addition, not all clinical locations have the facilities to carry out high quality food challenges.

Given these factors, efforts have been made to find diagnostic tests to predict the outcome of oral food challenges. These prognostic models have focused on decision points for sIgE or SPT, either independently or in combination resulting in predictive values of 61%-81%, which although useful, are not high enough for confident predictions of oral food challenges.

Furthermore, a history of anaphylaxis is often used to decide not to offer a food challenge although resolution of food allergy is still possible with such a history. So it appears other clinical factors are inconsistently considered and their impact on challenge outcome has previously never been evaluated systematically, although they are likely to be influential. In addition, when a patient falls within an immunological grey area (i.e. below the 95% cut off point for ‘certain reactivity’ but above a level that would predict a negative outcome, usually a completely negative SPT or sIgE), there has not as yet been any method developed to confidently choose which of the two potential outcomes is most likely.

A paper entitled ‘Making Better Decisions: Construction of Clinical Scoring Systems by the Spielgelhalter: Knill-Jones Approach’ British Medical Journal published by Seymour et al discloses a system of scoring information that can help in making a diagnosis or establishing a prognosis in an individual patient. However a problem with the Seymour system is that it does not provide an accurate predictive ability of the allergic status of a patient.

US Patent Publication number US20080082364, Jung et al, discloses a computational system for bio-medical data, however as with the Seymour paper the system does not provide an accurate predictive ability of the allergic status of a patient.

A paper published by Kearney at al, entitled The Food Challenge Risk Index: Predicting Positive Open Food Challenges to Milk, Egg, and Peanuts in Children' discloses predicting positive results and uses SPT and sIgE and time since last reaction. However this has problems in prediction since some children are very avoidant and compliant and others are ‘risky’ in their behavior, which results that they are not still allergic to a particular food.

It is an object of the invention to overcome at least one of the above-referenced problems.

### STATEMENTS OF INVENTION

According to the invention there is provided, as set out in the appended claims, a computer implemented system for assessing the allergic status of a subject to a specific allergen, the system comprising:
means for determining a subject-specific numeric value for a plurality of variables comprising age, sex, SPT, IgE, and allergic symptoms;
means for applying an allergen-specific weighting to the numeric value for each variable; and
means for correlating the weighted numeric values with allergic status for the subject using a deterministic probability function.

The invention broadly relates to a method of assessing the allergic status of a subject, typically to a specific allergan, for example (pea)nut, milk or egg. The term “allergic status” should be understood to mean assessing or predicting whether the subject is allergic to the specific allergen, whether the subject is at risk of developing an allergy to a specific allergan, whether the subject is responding to a therapy aimed at alleviating or curing a food-related allergic reaction, determining a stop/continue point during a maintenance phase in oral immunotherapy, or determining whether an allergic response to a specific allergan has recurred in a subject. In a particular embodiment, the term should be understood to mean predicting the outcome of oral food challenge in a subject.

The system and method employs a number of subject-specific variables which are easily obtained from the subject, wherein the combination of variables may be correlated with risk of an allergic reaction to the specific allergen. The method of the invention provides higher sensitivity and specificity than existing methods of predicting risk of allergic reaction such as specific sIgE, SPT, or sIgE in combination with SPT. The method involves determining a value for the age, sex, STP, IgE (for example specific IgE (sIgE) or total minus specific IgE (tIgE-sIgE)), and symptoms, for the subject, applying an allergan-specific weighting to the values, and correlating the weighted values with risk of the subject being allergic to the specific allergen, typically by means of a linear regression model. It will be appreciated that the total IgE has never been taken into account before in relation to diagnosis.

The inventors found that ‘Grade of symptoms’ or history of reactions emerged as one of the strongest predictors that provides a technical advantage in the processing steps to determine the allergic status of a subject. A child, for example, who is suspected of having peanut allergy who has had a history of symptoms will have a higher relative risk for a positive outcome than a child with no symptoms, controlling for IgE result, SPT wheal diameter, sex, and age. The symptoms themselves can be first each evaluated independently (and in combination with each other) in a series of univariate models and also with each of the other indicators present in the final model. Overall, the invention demonstrates the importance of taking multiple indicators (including sex and age) into account to enhance prognostic ability rather than simply using sIgE and/or SPT. The optimum combination of symptoms (in ascending order of predictive ability) corresponded to a graded model. For example, gastrointestinal and upper respiratory symptoms are given a higher grade value when making a clinical decision on the likelihood of allergy. However, in both phases 2 and 3 it was found that upper respiratory and gastrointestinal, if present alone, had a weaker predictive value than upper respiratory and gastrointestinal symptoms presenting together. Indeed, the presence of any two (or more) symptoms from different biological systems had more weight in prediction, than multiple symptoms from one system, except for lower respiratory and cardiovascular. Thus, each of the 4 symptom levels has its own estimator with no symptoms (0) as the indicator, and calculated according the system and method of the invention.

It will be appreciated that ‘time since reaction’ did not contribute to the models during any phase, because. It is this variable that is usually taken into account and not age. But, much research (our own and others) show that children can be ‘avoidant’ or ‘risky’ in their behavior. Thus, if a child has not had a reaction for 1, 2, or even 10 years, this does not mean that they are no longer allergic to a particular food, it means that they may be very risk averse and may have a very restricted diet (controlled by parents, very often). Age can have a significant effect on the outcome. It will be appreciated that sIgE, SPT and total IgE may also change over time, and the algorithm of the present invention accounts for all of these changes.

In one embodiment at least six variables are employed including age, sex, SPT, tIgE minus sIgE, and allergic symptoms.

In one embodiment the deterministic probability function comprises using a linear regression model P=ez/(1+ez) in which:
P=predicted allergenicity status for the subject;
e=mathematical constant (2.71828 . . . ); and
z=linear combination of the weighted numeric values for the variables.

In one embodiment z=a linear combination x and β, in which x is the numerical value for a given variable, and β is the allergen-specific weighting (estimator) for that variable.

In one embodiment the weighted numeric values are correlated with allergenicity status using a linear regression model: P=[e(α+β1x1+ββ2x2+ . . . +βqxq)]/[1+e(α+β1x1+β2x2+ . . . +βqxq)], wherein α is a constant.

In one embodiment the numeric value for sex is 0 for a female and 1 for a male.

In one embodiment the numeric values for allergic symptoms are 1, 2, 3 and 4, in which 1 correlates with skin or oral or gastrointestinal or upper respiratory symptoms, 2 correlates with upper respiratory and gastrointestinal symptoms (or two systems), 3 correlates with lower respiratory symptoms (or three systems), and 4 correlates with cardiovascular (or four systems).

In one embodiment the peanut-specific weighting values (estimators) are selected from −0.37 for age, 4.6 for sex, 2.85 for STP, 0.5 for sIgE, −0.002 for tIgE-sIgE, and 3.32, 4.61, 7.86, and 11.08 for allergic symptoms numeric values 1, 2, 3, and 4, respectively.

In one embodiment the egg-specific weighting values (estimators) are selected from −0.15 for age, 1.7 for sex, 0.29 for STP, 0.52 for sIgE, −0.004 for tIgE-sIgE, and 1.4, 2.08, 2.74, and 3.76 for allergic symptoms numeric values 1, 2, 3, and 4, respectively.

In one embodiment the milk-specific weighting values (estimators) are selected from −0.15 for age, 0.59 for sex, 0.35 for STP, 1.8 for sIgE, −0.006 for tIgE-sIgE, and 0.48, 2.36, 7.92, and 8.51 for allergic symptoms numeric values 1, 2, 3, and 4, respectively.

In a further embodiment there is provided a method of assessing the allergic status of a subject to a specific allergen, the method comprising the steps of determining a subject-specific numeric value for a plurality of variables comprising age, sex, SPT, IgE, and allergic symptoms, applying an allergen-specific weighting to the numeric value for each variable, and correlating the weighted numeric values with allergic status for the subject.

In one embodiment, the IgE is specific IgE (sIgE). In a preferred embodiment, two IgE values are employed, namley specific IgE (sIgE) and total IgE minus specific IgE (tIgE−sIgE).

Thus, in a preferred embodiment, the invention relates to a method of assessing the allergic status of a subject to a specific allergen, the method comprising the steps of determining a subject-specific numeric value for a plurality of variables comprising age, sex, SPT, tIgE-sIgE, and allergic symptoms, applying a allergen-specific weighting to the numeric value for each variable, and correlating the weighted numeric values with risk of the subject being allergic to the allergan.

In one embodiment the method can be used to perform sensitivity analysis on each input. This will be particularly important for measuring the impact of wheal measurements, which can vary up to 20% between clinician.

The method of the invention is suitable for use with any allergen, especially peanut, egg, and milk.

The weighted numeric values are suitably correlated with allergenicity status using a linear regression model P=ez/(1+ez) in which:
P=predicted allergic status for the subject;
e=mathematical constant (2.71828 . . . ); and
z=linear combination of the weighted numeric values for the variables.

Preferably, z=a linear combination x and β, in which x is the numerical value for a given variable, and β is the allergan-specific weighting (estimator) for that variable.

Thus, in a preferred embodiment:

P=[e(α+β1x1+β2x2+ . . . +βqxq)]/[1+e(α+β1x1+β2x2+ . . . +βqxq)],

wherein α is a constant.

Typically, the numeric value for sex is 0 for a female and 1 for a male.

Suitably, the numeric values for allergic symptoms are 1, 2, 3 and 4, in which 1 correlates with skin or oral or gastrointestinal or upper respiratory symptoms, 2 correlates with upper respiratory and gastrointestinal symptoms (or two systems), 3 correlates with lower respiratory symptoms (or three systems), and 4 correlates with cardiovascular (or four systems).

SPT values are suitably provided in mm, sIgE values are typically provided in kUa/L, and tIgE-sIgE values are suitably provided in kUa. Age values are provided in years.

In a preferred embodiment, the peanut-specific weighting values (estimators) are selected from −0.37 for age, 4.6 for sex, 2.85 for STP, 0.5 for sIgE, −0.002 for tIgE-sIgE, and 3.32, 4.61, 7.86, and 11.08 for allergic symptoms numeric values 1, 2, 3, and 4, respectively.

In a preferred embodiment, the egg-specific weighting values (estimators) are selected from −0.15 for age, 1.7 for sex, 0.29 for STP, 0.52 for sIgE, −0.004 for tIgE-sIgE, and 1.4, 2.08, 2.74, and 3.76 for allergic symptoms numeric values 1, 2, 3, and 4, respectively.

In a preferred embodiment, the milk-specific weighting values (estimators) are selected from −0.15 for age, 0.59 for sex, 0.35 for STP, 1.8 for sIgE, −0.006 for tIgE-sIgE, and 0.48, 2.36, 7.92, and 8.51 for allergic symptoms numeric values 1, 2, 3, and 4, respectively.

It will be appreciated that the weighting values provided above are optimal weighting values and that weighting values within +/−20%, preferably +/−15%, more preferably within +/−10% of the optimal weighting values, may be employed in the method of the invention. Variation on the weighting values may be employed to account for genetic variation in the population.

The algorithm provides a predictive value (P) between 0 and 1 for allergic status to a specific allergan for a subject. A predictive value (P) less than 0.5 indicates a negative allergic status to the allergen (i.e. negative prediction of allergy), and a predictive value of 0.5 or greater indicates a positive allergic status to the allergen (positive prediction of allergy). The algorithm may also be employed to predict population threshold values for specific allergans.

The invention also relates to a method of monitoring a course of immunotherapy in a subject, which method comprises a step of assessing the allergic status of the subject according to a method of any of the invention. Suitably, when the subject has a positive allergic status the immunotherapy is continued. Thus, the method of the invention may be employed to determine a stop/continue point during the maintenance phase in oral immunotherapy. Typically, when the subject has a negative allergic status, the immunotherapy is discontinued. In one embodiment, the method involves a step of determining the allergic status of the subject prior to the start of the course of therapy, and monitoring the allergic status of the subject periodically during the course of therapy to determine the effectiveness of the therapy.

The invention also relates to a method of assessing allergic status in an individual to a specific allergen comprising a step of correlating a value for tIgE-sIgE for the subject with allergic status. Thus, for example, as the tIgE-sIgE value decreases, the subject has a decreased likelihood of a positive allergic status, and when the tIgE-sIgE value increases, the subject has an increased likelihood of a positive allergic status.

It will be appreciated that the linear regression model P=exp(z)/{1+exp(z)} for z<0 is mathematically equivalent to a MacLaurin series expansion:

P={1+z+z2/2!+z3/3!+ . . . +zm/m!}/{2+z+z2/2!+z!+ . . . +zm/m!}

Modeling reveals the polynomial expansion is 95% accurate for m=2; 97% accurate for m=3; and 99% accurate for m=4. The results can be attained with reasonable experimental accuracy, according to the methodology of the present invention, using the formula:

P={1+z+z2/2!}/{2+z+z2/2!}

It will be further appreciated that other polynomial series approximation techniques can be employed in order to provide the deterministic probability function to achieve the results of the present invention.

In a further embodiment there is provided a device, for example a hand-held device, a mobile or cellular telephone, comprising a computer processing means for assessing the allergic status of a subject to a specific allergen, the processing means comprising:
means for determining a subject-specific numeric value for a plurality of variables comprising age, sex, SPT, IgE, and allergic symptoms;
means for applying an allergen-specific weighting to the numeric value for each variable;
means for correlating the weighted numeric values with allergic status for the subject using a deterministic probability function; and
means for displaying the allergic status on a graphical user interface.

There is also provided a computer program comprising program instructions for causing a computer program to carry out the above method which may be embodied on a record medium, carrier signal or read-only memory. Thus, the methods of the invention may be carried out using a computer program, in which a user inputs numeric data relating to the subject-specific variables, and the computer program correlates the input data with allergic status. The computer program that is employed may be carried on a user's computer (locally), or may be accessed from a remote server via the internet.

### BRIEF DESCRIPTION OF THE DRAWINGS

The invention will be more clearly understood from the following description of an embodiment thereof, given by way of example only, with reference to the accompanying drawings, in which:

FIG. 1 illustrates a computer system architecture configured to implement the invention according to one embodiment of the invention.

### DETAILED DESCRIPTION OF THE INVENTION

The invention will be more clearly understood from the following description of some embodiments thereof given by way of example only.

Variables

The preferred implementation of this invention utilizes the following variables:
Sex
Age
Grade of reaction
sIgE
Total IgE minus (−) sIgE
SPT

Grade of Reaction

The grades for allergic symptoms are 1, 2, 3 and 4, in which:
1 correlates with skin or oral or gastrointestinal or upper respiratory symptoms;
2 correlates with upper respiratory and gastrointestinal symptoms (or two systems);
3 correlates with lower respiratory symptoms (or three systems); and
4 correlates with cardiovascular (or four systems).

A subject, for example, who is suspected of having peanut allergy and who has had a history of Grade 2 symptoms will have a higher odds ratio for a positive outcome than a subject with Grade 1 symptoms or with no symptoms, controlling for IgE result, SPT wheal diameter, sex, and age.

Food allergy occurs when the body's immune system mounts an exaggerated response against the offending food, which acts as an allergen. It is a type of hypersensitivity reaction.

In an IgE-mediated reaction, symptoms involving the oropharynx and gastrointestinal tract may occur within minutes of ingesting a food allergen. Itching and swelling of the lips, tongue, and soft palate may occur alone or in addition to gastrointestinal symptoms such as nausea, abdominal pain, vomiting, and diarrhea. Symptoms in the respiratory tract include wheezing or shortness of breath.

In summary, food allergy reactions can affect any of the four following areas of the body or systems:

skin: itchy red bumps (hives); eczema; redness and swelling of the face or extremities; itching and swelling of the lips, tongue, or mouth (skin reactions are the most common type of reaction)

gastrointestinal tract: abdominal pain, nausea, vomiting, or diarrhea

respiratory tract: runny or stuffy nose, sneezing, coughing, wheezing, shortness of breath

cardiovascular system: lightheadedness or fainting

A serious allergic reaction with widespread effects on the body is known as anaphylaxis. This sudden, potentially life-threatening allergic reaction involves two or more of the body areas listed above. In addition, there also can be swelling of the airway, serious difficulty with breathing, a drop in blood pressure, loss of consciousness, and in some cases, even death.

SPT

Skin prick testing was performed by using positive control (histaminedihydrochloride 10 mg/mL), negative control (50% glycerol and 50% buffered saline), the potential food allergen (ALK-Abello, Reading UK), and single headed lancet. Skin reactions were recorded after 15 minutes. Positive test was a wheal of 3 mm. The size of the wheal was determined as the mean of two perpendicular longest diameters. Serum specific IgE was measured by using the Unicap system (Phadia, Uppsala, Sweden) and results were reported in kUa/L.

Estimators (Bᵥₐᵣ)

Data from Group B.

| | | | | | |
|---|---|---|---|---|---|
| | | | p- | | |
| Allergen | Indicators | b-estimate | value | Odds ratio | C.I. |

Peanut*

| | | | | | |
|---|---|---|---|---|---|
| | Male | 4.60 | 0.03 | 96.4 | 46.1-128.5 |
| Grade of | 1 | 3.32 | 0.01 | 27.5 | 15.9-46.2 |
| symptoms** | 2 | 4.61 | 0.05 | 97.4. | 48.6-154.0 |
| | 3 | 7.86 | 0.04 | 231.5 | 136.7-365.3 |
| | 4 | 11.08 | 0.01 | 613.2 | 414.0-870.2 |
| | SPT (mm) | 2.85 | 0.01 | 16.9 | 10.4-24.6 |
| | sIgE (kUa/L) | 0.50 | 0.04 | 1.6 | 1.2-2.0 |
| | IgE-sIgE | −0.002 | 0.01 | 1.2 | 1.0-1.4 |
| | (kUa) | | | | |
| | Age (years) | −0.37 | 0.05 | 0.69 | 0.3-0.9 |
| | Constant | −11.63 | 0.01 | | |

Egg*

| | | | | | |
|---|---|---|---|---|---|
| | Male | 1.70 | 0.04 | 5.5 | 3.5-8.0 |
| Grade of | 1 | 1.40 | 0.01 | 4.0 | 2.3-10.3 |
| symptoms** | 2 | 2.08 | 0.03 | 8.1 | 6.6-11.3 |
| | 3 | 2.74 | 0.01 | 15.2 | 10.4-18.9 |
| | 4 | 3.76 | 0.02 | 43.5 | 33.2-68.0 |
| | SPT(mm) | 0.29 | 0.01 | 1.30 | 1.1-3.1 |
| | IgE-sIgE | −0.004 | 0.04 | 1.21 | 1.0-1.3 |
| | (kUa) | | | | |
| | sIgE (kUa/L) | 0.20 | 0.01 | 1.22 | 1.1-1.7 |
| | Age (years) | −0.15 | 0.03 | 0.80 | 0.5-0.9 |
| | Constant | −2.42 | 0.01 | | |

Milk*

| | | | | | |
|---|---|---|---|---|---|
| | Male | 0.59 | 0.05 | 1.81 | 1.3-2.5 |
| Grade of | 1 | 0.48 | 0.05 | 1.62 | 1.4-1.8 |
| symptoms** | 2 | 2.36 | 0.03 | 3.01 | 1.8-4.6 |
| | 3 | 7.92 | 0.02 | 25.50 | 18.1-393.0 |
| | 4 | 8.51 | 0.02 | 46.4 | 27.6-66.3 |
| | SPT (mm) | 0.35 | 0.05 | 1.41 | 1.0-2.4 |
| | IgE-sIgE | −0.006 | 0.01 | 1.3 | 1.1-4.2 |
| | (kUa) | | | | |
| | sIgE (kUa/L) | 1.8 | 0.01 | 5.9 | 3.9-10.1 |
| | Age (years) | −0.15 | 0.05 | 0.86 | 0.3-0.9 |
| | Constant | −14.61 | 0.02 | | |

*Food being challenged.
**Each of the 4 levels is has its own estimator with no symptoms (0) as the indicator. 1 = skin or oral or gastrointestinal or upper respiratory only; 2 = upper respiratory and gastrointestinal or 2 systems; 3 = lower respiratory or 3 systems; 4 = cardiovascular or 4 systems.

Multivariate regression analyses with data presented are b-estimates with P-value, odds ratio (OR) and confidence intervals (CI).

Correlating Variable Values with Risk

The values obtained for the variables are weighted using the above-referenced allergen-specific estimators, and correlated with allergenicity status using the following algorithm:

PFA=[exp(constant+Bₛₑₓ*sex+B_{symptoms}+B_{SPT}*SPT+B_{sIgE}*sIgE+B×(total IgE−sIgE)+B×age]/[1+exp constant+B×sex+B(symptoms grade)+B×SPT level+B×sIgE+B×(total IgE−sIgE)+B×age].

Where probability of food allergy diagnosis based on challenge is PFA

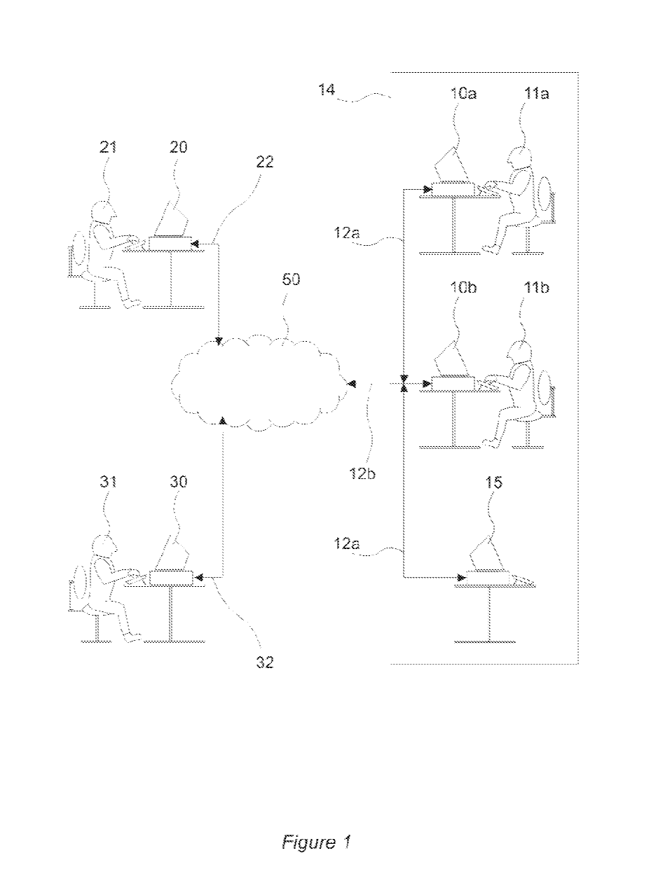

Referring now to FIG. 1, there is shown a network environment in which a system according to the invention may be embodied. The environment firstly includes a plurality of data processing terminals 10a, 10b operated by respective users 11a, 11b, for example clinicians or doctors, wherein the data processing terminals 10a, 10b each include networking means and are networked with one another by respective network connections 12a over a local network. Data processing terminals 10a, 10b are located at a medical facility 14 and each terminal 10a, 10b may be configured to operate substantially independently of and/or asynchronously relative to the other. In this embodiment, the data processing terminals 10a, 10b are configured as client terminals 10 and the environment at the medical facility 14 further includes a data processing terminal 15 configured as a server terminal. The server 15 includes networking means and is connected to the local network by a respective network connection 12a.

At least one of the data processing terminals 10a, 10b is further connected to a wide area network 50, for instance the World Wide Web or Internet, through a network connection means 12b. The network connection means 12b may be distinct from the local network and discrete to the data processing terminal, for instance by means of a cellular connection means. Alternatively, the network connection means 12b results from interfacing the local network with the wide area network by means of a World Wide Web or Internet router or the like whereby potentially all three terminals are connected to the wide area network 50. In this configuration, any of data processing terminals 20, 30 can log onto the server 15 over a web portal. The clinician or user inputs the data about a patient which is uploaded to the server 15. The data is processed, as described in more detail below, and a result is returned to the terminal 20, 30 over the wide area network indicative of the allergic status of the patient.

Each data processing terminal 10a, 10b, 15, 20 and 30 includes at least data processing means, specifically a microprocessor connected with data storage means; networking means; user input means, specifically an alpha numerical input device and optionally a pointing device; and display means to facilitate input, output and interaction of a user with its respective data processing terminal. There is therefore the scope, within the network environment shown in FIG. 1, for any of the networked data processing terminal 10a, 10b to broadcast data to, and receive data from, local server 15, and for any of the networked data processing terminal 10a, 10b to broadcast data to, and receive data from, the remote customer terminals 20 and 30.

The following sets out a number of examples to calculate whether a patient or subject has an allergy, using the system and method according to the invention:

### EXAMPLE 1

### Suspected Peanut Allergy

Male, 3 years of age, total IgE (−) sIgE of 1772 units, SPT level of 5 mm, sIgE of 10 KUa/L, a reaction history of skin swelling, vomiting and cough.

[exp(−11.63+(4.60×1)+11.08 +(5×2.85)+(10×0.50)+(1872×−0.002)+(3×−0.37))]/[1+exp(−11.63+(4.60×1)+11.08+(5×2.85)+(10×0.50)+(1872×−0.002)+(3×−0.37))]

The probability of a positive outcome is 1.0 for this child.

### EXAMPLE 2

### Suspected Milk Allergy

Male, 12 months of age, total IgE (−) sIgE of 170 units, SPT level of 6 mm, sIgE of 12 KUa/L, a reaction history of vomit, wheeze and eczema.

[exp(−14.61 +(0.59×1)+7.92+(6×0.35)+(12×1.8)+(170×−0.006)+1×−0.15)]/[1+exp(−14.61+(0.59×1)+7.92+(6×0.35)+(12×1.8)+(170×−0.006)+1×−0.15)]

The probability of a positive outcome is 1.0 for this child.

### EXAMPLE 3

### Suspected Egg Allergy

Female, 10 years of age, total IgE (−) sIgE of 1650 units, SPT level of 3 mm, sIgE of 9 KUa/L, and no previous history of reactions.

[exp(−2.42+(1.7×0)+(3×0.29)+(9×0.20)+(1650×−0.004)+(10×−0.15)]/[1+exp(−2.42+(1.7×0)+(3×0.29)+(9×0.20)+(1650×−0.004)+(10×−0.15)]

The probability of a positive outcome is 0.0004 for this child.

### EXAMPLE 4

### Suspected Peanut Allergy

Female, 8 years of age, total IgE (−) sIgE of 250 units, SPT level of 4 mm, sIgE of 5.19 KUa/L, and no previous history of reactions.

[exp(−11.63+(250×−0.002)+(4×2.846)+(4.60×0)+(5.19×0.50)+(8×−0.37)]/[1+(−11.63 +(250×−0.002)+(4×2.846)+(4.60×0)+(5.19×0.50)+(8×−0.37)]

The probability of a positive outcome is 0.251 for this child.

### EXAMPLE 5

The method of the invention was employed to predict allergenicity in a cohort of patients described in Table 1. Known methods of predicting allergenicity were also employed on the cohort. The outcome of the various methods of predicting are shown in Table 2.

TABLE 1
Demographic and clinical characteristics of group C.

| | Group C (N = 70) |
|---|---|
| Males | 50 (71%) |
| Age (Mean) | 8 (3.0) |
| History of reaction | 39 (56%) |
| Peanuts (%) | 30 (42%) |
| SPT level (Mean) | 5.4 (2.1) |
| sIgE level (Mean) | 8.2 (10.5) |
| Total IgE (Mean) | 1129 (842) |
| Milk (%) | 20 (29%) |
| SPT level (Mean) | 5.0 (2) |
| sIgE level (Mean) | 8.7 (12) |
| Total IgE (Mean) | 1043 (1166) |
| Egg (%) | 20 (29%) |
| SPT level (Mean) | 5.2 mm (2.5) |
| sIgE level (Mean) | 8.1 kUa/L (10) |
| Total IgE (Mean) | 1209 kU (983) |
| No previous history | 31 (44%) |
| Skin or oral or | 11 (16%) |
| gastrointestinal or | |
| upper respiratory | |
| only | |
| Upper respiratory | 17 (24%) |
| and gastrointestinal | |
| or 2 systems | |
| Lower respiratory or | 8 (12%) |
| 3 systems | |
| Cardiovascular or 4 | 3 (4%) |
| systems | |
| Diagnosis Positive | |
| Peanuts | 52 (74%) |
| Milk | 49 (71%) |
| Egg | 51 (73%) |

TABLE 2
Data from Group C (N = 70).

| Diagnostic method | Sensitivity | Specificity | Accuracy |
|---|---|---|---|
| sIgE only | 75% | 45% | 61% |
| SPT only | 85% | 65% | 75% |
| sIgE & SPT | 87% | 75% | 81% |
| Present Invention | 97% | 96% | 96% |

The data in Table 2 shows that the method of the invention provides superior sensitivity and specificity compared to the sIgE, SPT, and sIgE and SPT, methods of prediction.

### EXAMPLE 6

In another embodiment, only 5 variables are used to predict food test outcome, these are:
Sex
Age
Grade of reaction
sIgE
SPT

These are used in the following equation:

PFA=[exp(constant+Bₛₑₓ*sex+B_{symptoms}+B_{SPT}*SPT+B_{IgE}*sIgE+B×age)]/[1+exp(constant+Bₛₑₓ*sex+B_{symptoms}+B_{SPT}*SPT+B_{IgE}*sIgE+B×age)],

where probability of food allergy diagnosis based on challenge is PFA

No allergen specific modification was made to the algorithm's coefficients on an allergen by allergen basis.

With a test set of 429 as described by Table 3, this model (with coefficients from Table 4) had 80% accuracy in correctly predicting positive outcomes and 75% accuracy in negative outcomes.

TABLE 3
Demographic and clinical characteristics of group A.

| | Group A (N = 429) |
|---|---|
| Males | 283 (66%) |
| Age (Mean) | 7 (3.7) |
| History of reaction | 292 (68%) |
| Peanuts (%) | 239 (56%) |
| SPT level (Mean) | 4.0 (2.2) |
| sIgE level (Mean) | 5.8 (4.0) |
| Total IgE (Mean) | — |
| Milk (%) | 110 (26%) |
| SPT level (Mean) | 3.7 (2.8) |
| sIgE level (Mean) | 6.0 (4.1) |
| Total IgE (Mean) | — |
| Egg (%) | 80 (18%) |
| SPT level (Mean) | 3.8 mm (3.1) |
| sIgE level (Mean) | 5.7 kUa/L(3.6) |
| Total IgE (Mean) | — |
| No previous history | 137 (32%) |
| Skin or oral or | 82 (19%) |
| gastrointestinal or | |
| upper respiratory | |
| only | |
| Upper respiratory | 137 (32%) |
| and gastrointestinal | |
| or 2 systems | |
| Lower respiratory or | 60 (14%) |
| 3 systems | |
| Cardiovascular or 4 | 13 (3%) |
| systems | |
| Diagnosis Positive | |
| Peanuts | 163 (38%) |
| Milk | 172 (40%) |
| Egg | 167 (39%) |

TABLE 4
Estimators for all foods

| | | p- | | |
|---|---|---|---|---|
| Indicators | b-estimate | value | Odds ratio | C.I. |
| High SPT* | 4.10 | .050 | 8.18 | 4.5-11.2 |
| High IgE** | 2.26 | .045 | 3.54 | 2.1-5.8 |
| Male | 1.55 | .033 | 2.86 | 1.9-4.4 |
| Age <7 years | 1.50 | .050 | 1.43 | 1.1-3.9 |
| History of | 2.40 | .044 | 1.49 | 1.2-3.7 |
| reaction | | | | |
| Constant | −3.07 | .007 | | |

*≧8 mm (peanut and milk), ≧7 mm (egg)
**≧15 kUa/L (peanut and milk), ≧7 kUa/L (egg).

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described which may be varied in construction, detail, and process step, without departing from the scope of the invention.

1. A computer implemented system for assessing the allergic status of a subject to a specific allergen, the system comprising:
means for determining a subject-specific numeric value for a plurality of variables comprising age, sex, SPT, IgE, and allergic symptoms;
means for applying an allergen-specific weighting to the numeric value for each variable; and
means for correlating the weighted numeric values with allergic status for the subject using a deterministic probability function.

2. A computer implemented system as claimed in claim 1 in which at least six variables are employed including age, sex, SPT, tIgE minus sIgE, and allergic symptoms.

3. A computer implemented system as claimed in claim 1 in which the deterministic probability function comprises using a linear regression model P=ez/(1 +ez) in which:
P=predicted allergenicity status for the subject;
e=mathematical constant (2.71828 . . . ); and
z=linear combination of the weighted numeric values for the variables.

4. A computer implemented system as claimed in claim 1 in which the deterministic probability function comprises using a linear regression model P=ez/(1 +ez) in which:
P=predicted allergenicity status for the subject;
e=mathematical constant (2.71828 . . . ); and
z=linear combination of the weighted numeric values for the variables, wherein z=a linear combination x and β, in which x is the numerical value for a given variable, and β is the allergen-specific weighting (estimator) for that variable.

5. A computer implemented system as claimed in claim 1 in which the deterministic probability function comprises using a linear regression model P=ez/(1+ez) in which:
P=predicted allergenicity status for the subject;
e=mathematical constant (2.71828 . . . ); and
z=linear combination of the weighted numeric values for the variables, and wherein the weighted numeric values are correlated with allergenicity status using a linear regression model: P=[e(α+β1x̂1+βx\hat{'}2+ . . . +βqx̂q)]/[1+e(α+β1x̂1+β2x2+ . . . +βqx̂q)], wherein α is a constant.

6. A computer implemented system as claimed in claim 1 in which the numeric value for sex is 0 for a female and 1 for a male.

7. A computer implemented system as claimed in claim 1 in which the numeric values for allergic symptoms are 1, 2, 3 and 4, in which 1 correlates with skin or oral or gastrointestinal or upper respiratory symptoms, 2 correlates with upper respiratory and gastrointestinal symptoms (or two systems), 3 correlates with lower respiratory symptoms (or three systems), and 4 correlates with cardiovascular (or four systems).

8. A computer implemented system as claimed in claim 1 in which the peanut-specific weighting values (estimators) are selected from −0.37 for age, 4.6 for sex, 2.85 for STP, 0.5 for sIgE, −0.002 for tIgE-sIgE, and 3.32, 4.61, 7.86, and 11.08 for allergic symptoms numeric values 1, 2, 3, and 4, respectively.

9. A computer implemented system as claimed in claim 1 in which the egg-specific weighting values (estimators) are selected from −0.15 for age, 1.7 for sex, 0.29 for STP, 0.52 for sIgE, −0.004 for tIgE-sIgE, and 1.4, 2.08, 2.74, and 3.76 for allergic symptoms numeric values 1, 2, 3, and 4, respectively.

10. A computer implemented system as claimed in claim 1 in which the milk-specific weighting values (estimators) are selected from −0.15 for age, 0.59 for sex, 0.35 for STP, 1.8 for sIgE, −0.006 for tIgE-sIgE, and 0.48, 2.36, 7.92, and 8.51 for allergic symptoms numeric values 1, 2, 3, and 4, respectively.

11. A system of monitoring a course of immunotherapy in a subject, which method comprises means of assessing the allerginicity status of the subject according to the system of claim 1 at least once during the course of the immunotherapy.

12. A system as claimed in claim 11 for use in determining a stop/continue point during the maintenance phase in oral immunotherapy.

13. A computer program comprising program instructions for causing a computer program to control the system of claim 1 which may be embodied on a record medium, carrier signal or read-only memory.

14. A method of assessing the allergic status of a subject to a specific allergen, the method comprising the steps of:
determining a subject-specific numeric value for a plurality of variables comprising age, sex, SPT, IgE, and allergic symptoms; applying an allergen-specific weighting to the numeric value for each variable; and
correlating the weighted numeric values with allergic status for the subject using a deterministic probability function.

15. A method as claimed in claim 14 in which at least six variables are employed including age, sex, SPT, tIgE minus sIgE, and allergic symptoms.

16. A method as claimed in claim 14 in which the deterministic probability function comprises a linear regression model P=ez/(1+ez) in which:
P=predicted allergenicity status for the subject;
e=mathematical constant (2.71828 . . . ); and
z=linear combination of the weighted numeric values for the variables.

17. A method as claimed in claim 14 in which the deterministic probability function comprises a linear regression model P=ez/(1+ez) in which:
P=predicted allergenicity status for the subject;
e=mathematical constant (2.71828 . . . ); and
z=linear combination of the weighted numeric values for the variables, in which z=a linear combination x and β, in which x is the numerical value for a given variable, and β is the allergen-specific weighting (estimator) for that variable.

18. (canceled)

19. A method as claimed in claim 14 in which the numeric value for sex is 0 for a female and 1 for a male.

20-25. (canceled)

26. A device comprising a computer processing means for assessing the allergic status of a subject to a specific allergen, the processing means comprising:
means for determining a subject-specific numeric value for a plurality of variables comprising age, sex, SPT, IgE, and allergic symptoms;
means for applying an allergen-specific weighting to the numeric value for each variable;
means for correlating the weighted numeric values with allergic status for the subject using a deterministic probability function; and
means for displaying the allergic status on a graphical user interface.
